(19) United States
(12) Patent Application Publication
(10) Pub. No.: US 2005/0177527 A1
(43) Pub. Date: Aug. 11, 2005

(54) Transaction management tool

(76) Inventors: Glyn Phillip Morris, Hagley (GB); Derek John Southall, Edgbaston (GB)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 10/776,668

(22) Filed: Feb. 11, 2004

(51) Int. Cl. G06F 17/60

(52) U.S. Cl. 705/400; 705/1

(57) ABSTRACT

A management tool for a professional services firm that is operable to use historical billing information for a plurality of like, but completed matters to provide useful management information. More specifically, the tool is operable to determine an estimate for a new matter using the historical billing information; calculate the number of professional hours and grade of fee earner for that new matter in order to meet an estimated fee, again, using the historical billing information and provide an indication of the cost as a function of time for both the historical matters and the new matter. The tool is also operable to provide a report that includes a plot of costs incurred as a function of time for the historical information and the new live matter, so that a direct comparison can be made, as well as information relating to historical costs and current costs, and a billing analysis.

### BACKGROUND OF THE INVENTION

1. Field of the Invention

The present invention relates to a transaction management tool for use by professional service firms for providing realistic quotes and control over transaction revenues. This is done by costing and managing new transactions based on historical billing information.

2. Description of Related Art

Estimating fees is becoming an important part of the process of client management for professional service firms, such as lawyers. This is because clients are becoming more cost sensitive, and are increasingly pressing for upfront fixed price estimates. This can cause problems for professional service firms, because estimating costs is notoriously difficult. Indeed several law firms have been sued for estimating the cost of doing a job at a relatively low level but subsequently billing many times more. For example, in the UK in 2002, the law firm Beechcroft Wansborough was successfully sued by an ex-client and had to return around £125,000 after the estimates they gave rose significantly above the original projection. The Judge who presided over the Beechcrofts case said that “time and time again” the English Courts are having to deal with law firms who fail to meet statutory requirements for them to update clients about rising costs.

Despite the increasing awareness of problems with providing estimates, at present many law firms still cost jobs on a fairly ad hoc basis. For example, it is still often the case that a partner in charge of a project estimates the cost of transactions merely based on his own perception of previous experience. Regrettably, a person's recollection of what was done in the past is often flawed, and so this can be very unreliable. Estimating costs can be even more problematic where a cross-disciplinary team is needed and where a large number of people are likely to be involved.

The problems associated with estimating costs are well-known in the professional services market. To provide some form of assistance various software tools are available. For example, the website www.legalbudgets.com provides a facility for giving estimates of the cost for litigation and personal injury cases. This allows users to complete some details on line and then receive an assessment of how many professional hours a case is likely to take based on the size of the claim, the complexity of the case and the geographical location of the lawyers. It is believed that this process is based on publicly available rates for lawyers of different grades and in different parts of the country/world and requires an element of judgment on the part of the provider who uses industry knowledge to arrive at the ultimate figures. However, whilst this can provide some useful information, there is a need for an improved solution.

### SUMMARY OF THE INVENTION

According to a first aspect of the invention, there is provided a management tool for a professional services firm for estimating the cost of a new matter, such as litigation and/or an employee tribunal, the tool being operable to identify or extract from a memory details of billed amounts for like, but completed matters and determine an estimate of the cost for the new matter using the billed amounts for the like, completed matters.

By using billing information for real completed jobs carried out by a firm, a number of advantages are provided. In particular, since the estimate is based on actual performance, the estimate is based on real data, and not amounts simply expected of the industry or market. It also gives a realistic profile of what has happened before and so arrives at a very realistic budget. This is because the budget can be formulated based on what has actually happened in the past not what was perceived to have happened or what the firm would like to happen. Furthermore, each budget can be tailored so that the sample of data used to predict the outcome is as relevant as possible to the transaction being started. Transactions for a specific work-type, lawyer, client or team could be used to meet any cost constraints. In addition, once a base budget has been established then it can be tailored to account for bespoke circumstances that the service provider is aware of for particular cases.

Preferably, the management tool is operable to extract the details of billed amounts from a database or file that includes details of billed amounts for a plurality of different transactions. The database of billed information may be included in the firm's billing system or may be derived therefrom.

The billed details include the number of professional hours billed. The details of the billed amounts may further include any one of the number of fee earners involved; the grade of each fee earner and the time taken to complete the matter. The details of the billed amounts may also include disbursements, such as photocopying charges, fees for external service providers, such as barristers, and other amounts that have to be re-billed to the client. For patent agents, the details of the billed amounts may include fees that are payable to the Patent Office.

The management tool may be operable to determine the estimated amount based on an average over a plurality of completed matters. Preferably, the management tool is operable to determine the estimated amount based on an average number of hours of work done, averaged over a plurality of completed matters, and using current or agreed billing rates. Typically the rates are adjusted by using a suitable scaling factor to ensure that the estimate is represented using current rates.

Preferably, the management tool is operable to use cost/time-spread information to provide an indication of what percentage of costs are incurred at what stage of a matter. Preferably, the management tool is operable to present the time-spread information graphically. The management tool may be operable in the event that the new matter becomes live, to provide an indication of the time spread of live billing data for the new matter as percentage of the estimated total and based on the estimated duration of the matter. This is key in managing the matter against the budget.

According to second aspect of the invention, there is provided a management tool for a professional services firm, the tool being operable to identify details of fees for professional hours billed and the grade or category of fee earners involved for a plurality of like, but completed matters, and use this information to determine what percentage of the total fee from the hours billed is provided by each grade or category of fee earner involved. The hours billed may be a cumulative total or may be an average.

Preferably, the tool is operable to receive a user input of an estimated fee and use this and the percentage cost provided by each grade of fee earner to calculate the amount of the estimated fee that can be allocated to each fee earner grade. The tool is also operable to determine the number of fee earner hours that correspond to the amount of the estimated fee allocated to each fee earner grade. Hence, very quickly it is possible to have a reasonable estimate of the numbers of hours that each grade of fee earner has to do to meet the estimated fee, and thereby provide an indication of how work should be spread across the team. This can be helpful, because it may indicate that the initial estimate is unrealistic and should be revised. Should this happen, the estimated fee can be re-entered and the tool is re-run to provide modified figures.

Another feature that has an impact on the cost is the composition of the team, i.e. how many hours of a certain grade of fee earner is needed. To provide a mechanism for determining the impact of the team members' grade on the cost, the tool is operable to allow the composition of the team to be varied, and use the new team data to calculate the numbers of hours each team member would have to do to keep within the estimated fee or to adhere to a specified margin. As yet another option, the tool may be operable to allow the hourly billing rates and/or the percentage of fee recovery to be changed. By percentage recovery it is meant the percentage of the hourly rate that is actually recovered or is recoverable.

According to a third aspect of the invention, there is provided a management tool for a professional services firm, the tool being operable to identify details of billed amounts for like, but completed matters, including an average cost and duration, and use this information to provide an indication of what costs are incurred at what stage of a matter.

Preferably, the costs are expressed as a percentage of the total cost, and the average duration is divided into predetermined time slots, again preferably expressed as a percentage of the total average duration. Preferably, the tool is operable to present in cost/time spread data graphically. The tool may also be operable to use billing data for a live matter, together with an estimate of the total fee and an estimated date of completion for that matter to provide an indication of the portion or percentage of the total fee used to date. The tool may be operable to present this information graphically. By comparing the cost/time spread for the live matter with the historical cost/time spread, a fee earner can establish whether a matter is running over budget. This is advantageous because in the event that costs are increasing faster than anticipated, the firm can address the issue by either re-assessing the composition of the team doing the work or the timetable, or by looking at whether circumstances have changed. In the event that the circumstances have changed, it may be that the firm has to revert to the client to let them know that the total cost may exceed the initial estimate, and explain why. Whilst this would not be ideal, keeping a client informed at every stage is essential for good client relations and overall transaction management.

### BRIEF DESCRIPTION OF THE DRAWINGS

Various aspects of the invention will now be described by way of example only and with reference to the accompanying drawings, of which:

FIG. 1 is a block diagram of a system including a transaction management tool;

FIG. 2 shows a graphical output from the transaction management tool;

FIG. 3 shows an example of a transaction report that includes a graphical representation of both live and historical data, and

FIGS. 4(a)-4(c) show an example of a report that can be output from the transaction management tool of FIG. 1.

### DETAILED DESCRIPTION

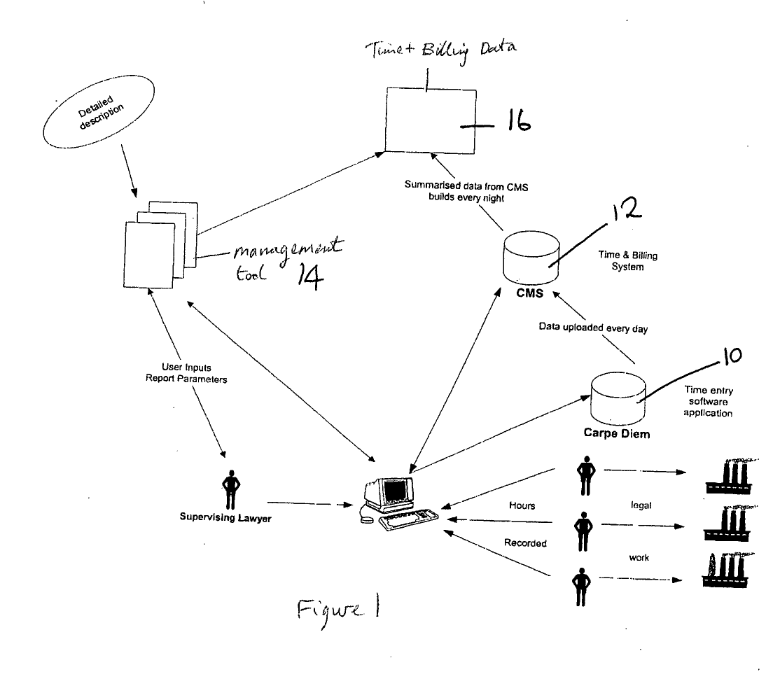

FIG. 1 shows the various components in a financial transaction system for use in a professional services firm. This includes a time entry software application 10, such as Carpe Diem, a time and billing system 12, such as CMS, for storing all live and historical billing data, and a management tool 14 that is operable to use billing data derived from the time and billing system 12 to provide accurate cost estimates and other useful management information. This will be described in more detail later.

The time entry software application 10 of FIG. 1 is operable to record the number of hours that particular professionals have spent working on specified jobs via a suitable user interface that is accessible using a PC. As is standard with most time entry systems, each legal transaction is allocated a unique number, against which time can be entered. Each fee earner is allocated a unique number or identifier so that recorded time can be associated directly with them. Optionally the software may be such as to allocate a further identifier to identify the particular type of work done. For example, specified identifiers may be provided for distinguishing between meetings, telephone calls and drafting work.

The time entry software application 10 is adapted to transfer all the professional time entered by each of the fee earners within the office to the time and billing system, together with an indication of the job number and the fee earner's unique identifier. Using this information, the billing system 12 determines a cost rate. This may be based on a charge rate as agreed by the client or a standard firm rate. Also entered into the billing system are details of all re-chargeable disbursements and any other charges, such as for photocopying services. The billing system 12 is operable to use its data entries to create and issue bills. When a bill is raised, a fourth value is assigned to the time transactions that will be referred to as the bill value. This is the actual real value for each hour of time incurred on the transaction. In practice, this will often be different to the charge rate and the standard rate because of fee negotiations made at the point of billing. For every billed matter, the billing system is capable of identifying how many hours were recorded; who recorded those hours; the seniority or grade of lawyer recorded that time; the legal team the individuals belong to and the length of transaction life cycle. This time and billing system information and in particular the historical information for previous completed jobs is, in accordance with the invention, used to provide estimates for future jobs.

To provide estimates based on historical data, information firstly has to be extracted from the time and billing system 12. This can be done using any suitable data extraction technique. However, as an example, for a billing system, such as CMS, that includes information in a plurality of distinct but linked data tables, rather than searching for information from each table to provide a complete picture of historical data for specified matters, it is preferred to download all of the system information in a single run to provide a single, complete table or listing 16 of all historical and live billing data summarised according to matter number. Preferably, this is done overnight, so that at the start of each working day, fee earners have access to the most up-to-date billing information. This information is stored in a suitable part of the system, and in any suitable format, such as Microsoft SQL, so that it can be retrieved and manipulated by the management tool 14 as and when desired.

The Management Tool

The management tool 14 has three modules that co-operate to provide estimates for new jobs, an indication of the composition of numbers and grade of attorneys needed, as well as a means for tracking on-going charges as a function of time and comparing them with time spread charges for like, but completed cases. To provide detailed reports and estimates, the management tool 14 typically needs five parameters to be entered. For each of these a data entry field is provided in a suitable user interface (not shown). The parameters needed include identification numbers for matters that are completed and billed, and are similar to the new matter; an estimated fee for the new matter; a matter number for the new matter in question; an estimated date for completion of the matter, and an estimated fee recovery, i.e. the expected hourly rate recovered expressed as a percentage of the standard hourly rate. These parameters and their uses will be described in more detail later.

The first module of the management tool 14 is a quoting module that is operable to provide an estimate for particular jobs based on the classification of that job and on the historical amounts billed for like, but completed jobs. Also provided is a scoping module for automatically establishing what proportion of partner/associate/other grade of fee earner time is needed to deliver a job to a required fee, profit or hours budgeted based on historical track record. This matrix can then be varied or flexed to achieve different results and margins. The final module is the management module which is operable to plot a transaction management curve showing the percentage increase in the value of time recorded, based on the data from historical transactions of that type. The management module is also operable to plot a comparative transaction management curve for a current, live transaction, so that actual fee distribution curves can be compared with a curve that is representative of average historical data for like, but completed matters. This means that at a relatively early stage, it will become apparent whether a transaction is likely to run over budget. Each of the modules will now be described in more detail.

Each of the three modules of the management tool 14 uses historical data for like but completed matters as the basis for providing useful management information. To allow suitable completed matters to be identified and selected, the management tool 14 may be operable to receive a user input that is indicative of the type of matter that is of interest, and then search the table of billing information for that type of matter, and present a list of the identified matters to the user. To refine the selection of the like matters further, the tool may be operable to receive user selections of one, preferably a plurality, of the matters in the list. A more refined selection typically needs professional input to identify matters that are closest to the new matter. The matter numbers could be entered manually by non-professional support staff.

The Quoting Module

Once the selected matter numbers are entered, the quoting module is operable to request or identify the billing data for those matter numbers and calculate the cumulative matter values for the sample. To do this, the quoting module is operable to calculate the average number of hours billed for each individual involved, and identify the grades of the attorneys who did the work, and use this information, together with current billing rates and any expected disbursements, to provide automatically an estimate of the cost for the new matter. The current billing rates for individuals may be stored for use by the quoting module. Alternatively, the management tool 14 may be operable to receive a user input of an agreed billing rate, which billing rate would subsequently be used by the quoting module. As yet another option, the tool may be operable to allow a realisation rate to be entered to reflect the current achievable billing rate, this rate being expressed as a fraction of the current hourly rate. As will be appreciated, basing the estimate on the average hours historically spent for like, but completed matters, and adjusting the total cost to take into account changes to billing rates makes the overall estimate more accurate.

The Scoping Module

As well as providing estimates based on historical billing data, the management tool 14 is operable to use the historical billing information and manipulate it to scope a job for which a fixed fee has been agreed or indeed to investigate whether the estimated fee could be reduced by redistributing effort and skills, by for example including more junior attorneys on the team. By scoping, it is meant determining the team that is needed to provide the work for the estimated amount based on the grade of the attorneys involved and the corresponding billing rates, and the hours that can be spent by each category of individual. To do this, the management tool 14 is operable to present a data field for the entry of an estimated fee, an estimated date for completion, and an estimated percentage fee recovery, i.e. the expected hourly rate that can be achieved relative to the firm standard fee rate. The scoping module of the tool is operable to use this to build an hours budget for the new matter, based on the historical data, and the estimates.

As a specific example of how the scoping module operates in practice, consider the situation where the quoting module has identified the following information for a new matter, based on historical data derived from the time and billing system:

Cumulative Data for Five Matters

| Grade | Team | Hours | | Rate | | Fees | % |
|---|---|---|---|---|---|---|---|
| Partner | Employment | 20 | @ | 220 | = | 4,400 | 10.2 |
| Partner | Litigation | 50 | @ | 260 | = | 13,000 | 30.1 |
| Senior | Litigation | 150 | @ | 172 | = | 25,800 | 59.7 |
| Lawyer | | | | | | 43,200 | 100.0 |

This data represents the sum of the hours and fees contributed by each category of individual for five sample matters, and the percentage of the total fee contributed by each category. For example, the employment partner(s) contributed £4400 of the total of £43200, that is 10.2% of the total. To obtain an average fee for the matter in issue, the fee total should be divided by the number of matters in the sample, in this case five.

The historical data shown above can be used to scope a new job. For example, if the estimated amount entered by the user is, say, £6000, the historical data can be used to estimate the time contribution needed by each of the parties involved. This is done by using the percentage of the total cost contributed by each party, and the desired estimated fee. These can be used to determine the number of hours each party has to do to deliver the work in order to stay within the estimated fee. For the present example, the scoping information derived from the scoping module is as follows:

New Transaction extrapolated using the % above—Estimated fee £6000

| | | | | | | | | Adjusted | Hours |
|---|---|---|---|---|---|---|---|---|---|
| | | | | | | | | Hourly | at Adj |
| | | Total | | | | Fee | Hour | Rate @ | Hourly |
| Grade | Team | Fee | | % | | Dist. | Rate | FR90% | Rate |
| Partner | Employment | 6,000 | @ | 10.2 | = | £610.80 | £250 | £225 | 2.7 |
| Partner | Litigation | 6,000 | @ | 30.1 | = | £1805.40 | £270 | £243 | 7.43 |
| Senior | Litigation | 6,000 | @ | 59.7 | = | £3583.20 | £190 | £171 | 20.95 |
| Lawyer | | | | 100.0 | | £6000.00 | | | |

Having this type of information readily available and based on accurate historical data is useful because it can highlight very quickly if and when the estimated or target fee is realistic. For instance, in the above example, it may be immediately apparent to the professional staff that the employment related work for the job could not be done in the estimated 2.7 hours. In this case, a decision may be taken to re-calculate the figures based on a senior attorney having a lower billing rate being used to do the work, rather than a partner. To allow for this type of calculation the management tool 14 is operable to allow the scoping data to be modified. In particular the tool is operable to allow the entry of different categories of fee earner and provide means, such as a user selectable re-calculate button or icon on the interface, for causing the scoping module to re-calculate the data using the modified information and so provide an indication of the impact on the number of hours needed. Other data that can be changed includes the hourly rate and the percentage fee recovery. In the event that the re-calculation indicates a more reasonable time estimate for doing the work, it may be decided that the estimated fee is acceptable. As well as providing scoping information based on an estimated fee, the scoping module may be operable to provide information based on a specified profit margin.

The Transaction Module

The final module of the management tool 14 is the transaction management module. This provides an indication of the cost for a job as a function of time, again based on historical information derived from the firm's billing system. In order to do this, the management tool 14 needs to know the start and close date for each of the matters in the sample of like, completed matters. For each matter, the duration is divided into predetermined amounts, for example, 20 ths. The fee value for every 5% time slot is then calculated as a % of the whole, as is the percentage increase for each time slot. This information is then averaged over all of the selected sample matters to provide an indication of the average time spread of the cost, expressed as a percentage of the total average cost. As an example, consider the following data:

Tabular Representation of Sample Results Percentage Timetable for the Sample

5% 10% 15% 20% 25% 30% 35% 40% 45% 50% 55% 60% 65% 70% 75% 80% 85% 90% 95% 100%
   Percentage of Total Fees Incurred for the Sample
11% 12% 14% 18% 21% 30% 33% 37% 40% 47% 56% 63% 67% 70% 75% 79% 86% 88% 93% 100%
   Percentage at Each 5%
11% 1% 2% 4% 3% 10% 3% 4% 3% 7% 9% 7% 4% 3% 5% 4% 7% 2% 5% 7%

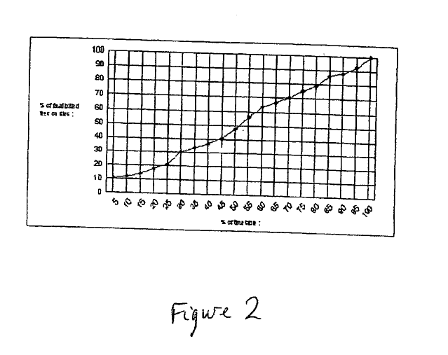

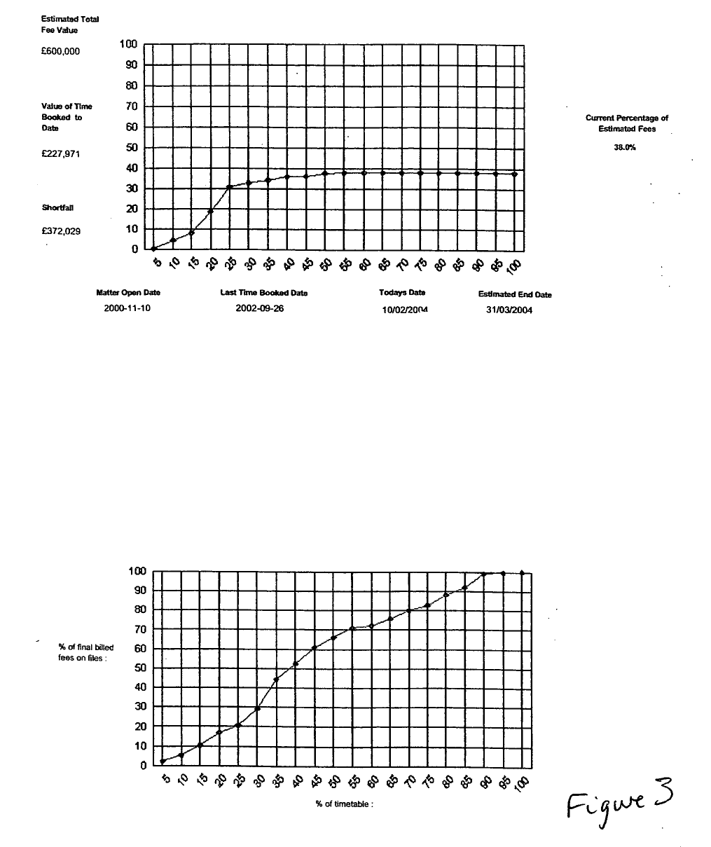

A graphical representation of this data is shown in FIG. 2. Having this type of information is useful for a professional services firm, because it allows resources to be allocated to specific projects in a more scientific and accurate manner. In addition, it provides a means for tracking whether the total real cost for a live project is likely to exceed the estimated amount. To do this, the transaction management module is operable to provide an indication of the on-going cost/time data for a live case. This is done using an estimated duration for the live project, an estimated cost and live real-time billing data. This information is processed in a manner similar to that for the historical data so that direct comparisons can be made, that is the estimated duration is divided into pre-determined time slots and the fee value at each stage is determined as a percentage of the total estimated amount. Cost/time data for the live transaction can be presented graphically, preferably on the same page of a report as the historical data, as shown in FIG. 3, or on the same graph. This allows for a detailed and immediate comparison of how the costs are being spread compared with the firm average for that type of transaction. This is extremely useful, because it can provide a very early warning as to whether a project is going to run over-budget, and allows the firm an opportunity to address any potential problems.

Implementation

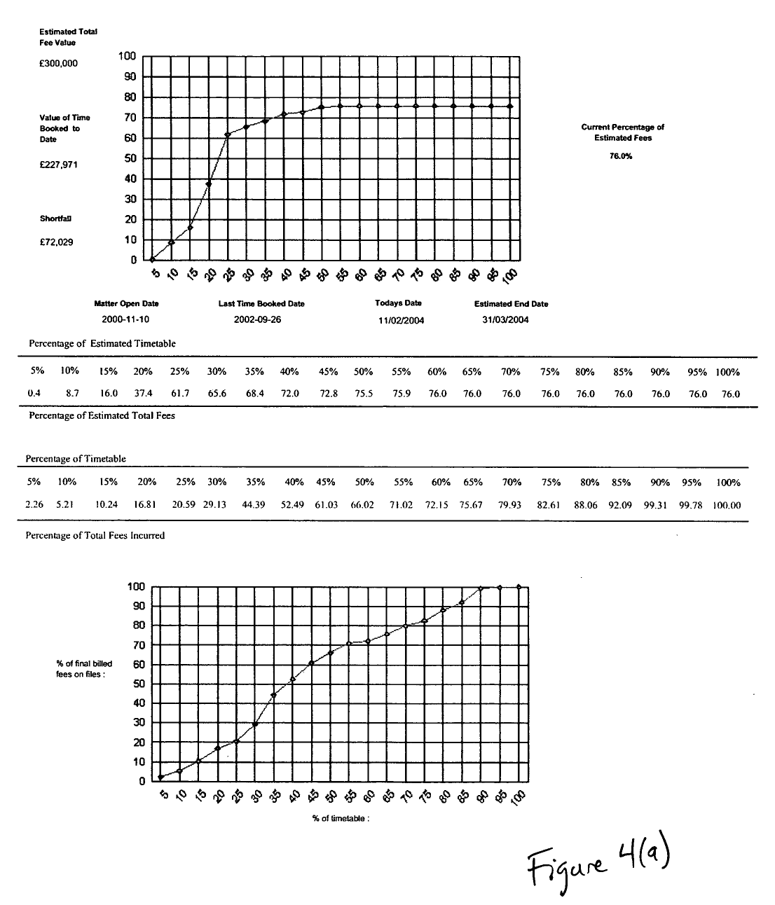

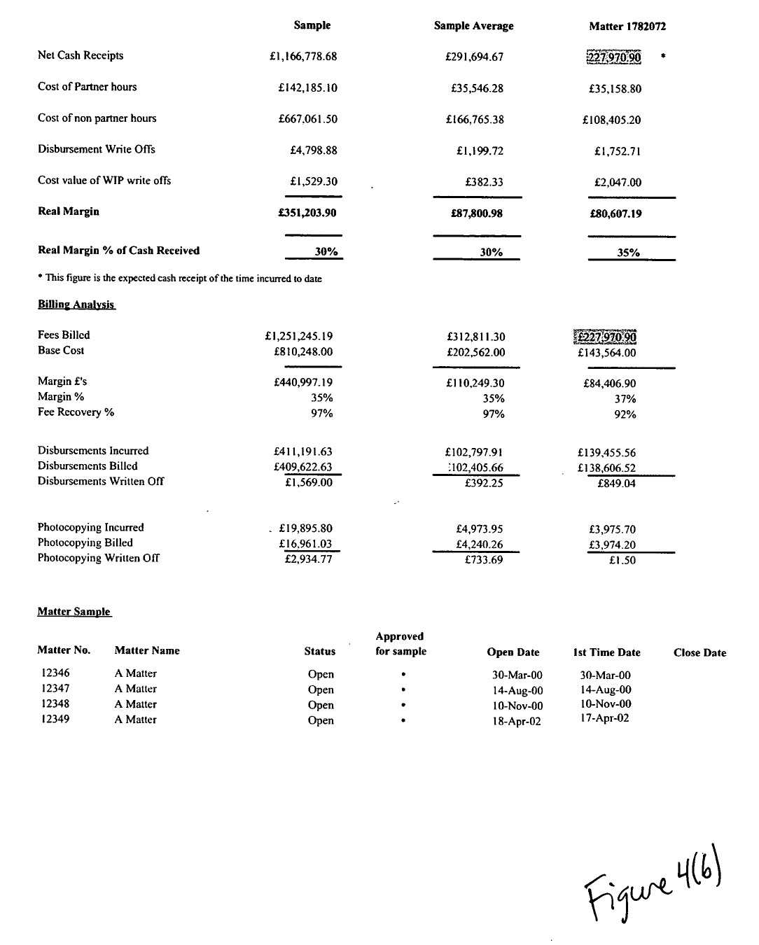

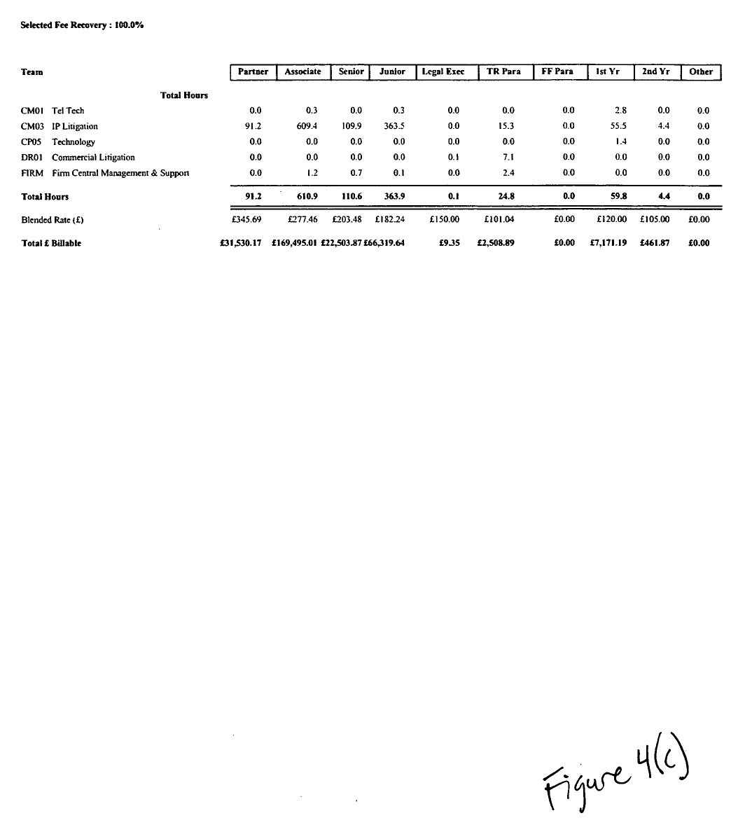

The management tool 14 in which the invention is embodied can be implemented using any suitable computer program/software on a computer readable medium, such as a custom written program or existing package that is modified to do the necessary calculations, so long as these have code and instructions suitable for carrying out the various calculations and functions needed for the management tool. For example, the software package “Crystal Enterprise” which is able to provide financial reports can be readily adapted to carry out the necessary calculations and present reports to a user. These reports can be presented in any suitable format. FIG. 4 shows an example of such a report. This includes numerical data and a graphical representation of the time spread of work for a live job. In this particular example, it can be seen that the estimated cost of the job is £300,000 and by about half way into the estimated time for the project about 75 percent of the estimated costs have been incurred. Presented on the same page are numerical data and a graphical representation of the corresponding data for like, but completed matters. This shows that for the completed matters, only sixty six percent of the budget was spent half way into the project. This provides a clear indication that half way into the project the matter was over budget. This would warrant a review of the project. Also included in the report of FIG. 4 are details of the billing analysis that is used to provide the estimates. This includes a breakdown of the teams involved in the completed but like matters, in terms of the individuals and their grades, as well as the number of hours contributed by each grade of individual, and the cumulative and average amounts billed. Included in the billing analysis are details of the cumulative and average disbursements incurred for the sample matters and amounts that were written off, as well as an indication of the historical margin and the estimated margin for the live matter. It should be noted that the report of FIG. 4 could be made available to clients, although in practice information relating to profit margins would not be included.

The means by which a user can access the software can be implemented using any suitable means. For example, an icon may be provided on the user's desktop computer, which icon provides a link to the management tool 14. Alternatively, the tool may be provided as an integral part of an internal billing system and may be accessible via that system. A skilled person will understand how to do this, and so the specific software used is not described herein in detail.

The management tool 14 in which the invention is embodied provides various advantages. Because it uses and interrogates the firm's own data, it can present a real and true indication of how the firm operates work. This can be done quickly, so that a detailed resource plan can be executed promptly. Furthermore, the level of skilled knowledge required to produce the report is very low, and the information can be refreshed and modified very easily.

Although the management tool 14 has various different data entry fields and is capable of providing comprehensive estimates and management information, once a sample of the historical data is agreed upon no specialist knowledge is needed in order to use it. Hence, a competent secretary or paralegal can produce the information for review by a supervising lawyer. The tool is operable to create the output almost instantly, so that it can be displayed, printed or e-mailed. The information can be refreshed regularly to track the actual results from the Practice Management system for the new transaction against the benchmark. Fee negotiations are more productive and it becomes much easier to broach the client on issues of scope creep, that is changes in resource requirements and the distribution of resources (e.g. more hours required or hours needed by different grades of individual) and increases in their requirements that would otherwise be wrapped up in the overall fee or not recovered. The management tool 14 acts as an early warning mechanism for transactions that are costing more than expected. The lawyer can then assess whether the issue is one of internal efficiency or whether to inform the client as soon as it is known that the costs are increasing.

A skilled person will appreciate that variations of the disclosed arrangements are possible without departing from the invention. Accordingly the above description of the specific embodiment is made by way of example only and not for the purposes of limitation. It will be clear to the skilled person that minor modifications may be made without significant changes to the operation described.

1. A fee estimation tool for a professional services firm for estimating the cost of a new matter, such as litigation and/or employee tribunal, the tool being operable to identify details of billed amounts for like, but completed matters and determine an estimate of the cost for the new matter using the billed amounts for the like, but completed matters.

2. A fee estimation tool as claimed in claim 1 that is operable to extract the details of billed amounts from a database or file that includes details of billed amounts for a plurality of different matters.

3. A fee estimation tool as claimed in claim 1 wherein the details of the billed amounts include any of the number of professional hours billed; the grade of fee earners involved; the time taken to complete the matter; the time spread of the charges; re-chargeable disbursements, and costs for other services, including photocopying.

4. A fee estimation tool as claimed in claim 1. that is operable to determine the estimated amount for a new matter based on an average over a plurality of completed matters.

5. A fee estimation tool as claimed in claim 1 that is operable to determine the estimated amount based on an average over a plurality of completed matters and corrected to take into account changes in hourly billing rates.

6. A fee estimation tool as claimed in claim 1 that is operable to use time spread information to provide an indication of what percentage of costs are incurred at what stage of a matter.

7. A fee estimation tool as claimed in claim 6 that is operable to present the time spread information graphically.

8. A fee estimation tool as claimed in claim 6 that is operable, in the event that the new matter becomes live, to provide an indication of the time spread of live billing data for the new matter as percentage of the estimated total and the estimated duration of the matter.

9. A management tool for a professional services firm, the tool being operable to identify details of fees for professional hours billed and the grade or category of fee earners involved for a plurality of like, but completed matters, and use this information to determine what percentage of the total fee from the hours billed is provided by each grade or category of fee earner involved.

10. A tool as claimed in claim 9 is operable to receive a user input of an estimated fee and use this and the percentage cost provided by each grade of fee earner to calculate the amount of the estimated fee that can be allocated to each fee earner grade, and the corresponding number of fee earner hours for each fee earner grade.

11. A tool as claimed in claim 9 that is operable to receive a user input of an estimated fee and allow the composition of the fee earner team to be varied, and use the new team data to calculate the numbers of hours each team member would have to do to keep within the estimated fee or a specified margin.

12. A management tool for a professional services firm, the tool being operable to identify details of billed amounts for like, but completed matters, including an average cost and duration, and use this information to provide an indication of what costs are incurred at what stage of a matter.

13. A tool as claimed in claim 12 wherein the costs are expressed as a portion or percentage of the total cost, and the average duration is divided into predetermined time slots and expressed as a a portion/percentage of the total average duration.

14. A tool as claimed in claim 12 that is operable to present the cost/time spread data graphically.

15. A tool as claimed in claim 12 that is operable to use billing data for a live matter, together with an estimate of the total fee and an estimated date of completion for that live matter to provide an indication of the portion of the total fee used to date.

16. A tool as claimed in claim 12 that is operable to use billing data for a live matter, together with an estimate of the total fee and an estimated date of completion for that live matter to provide an indication of the portion of the total fee used to date and to present cost/time spread information for the live matter graphically.

17. A management tool for a professional services firm that is operable to use historical billing information for a plurality of like, but completed to calculate the number of professional hours and grade of fee earner for a new, but similar matter in order to meet an estimated fee using the historical billing information and provide an indication of the cost as a function of time for both the historical matters and the new matter.

18. A management tool for a professional services firm that is operable to use historical billing information for a plurality of like, but completed matters to determine an estimate for a new matter; calculate the number of professional hours and grade of fee earner for that new matter in order to meet an estimated fee using the historical billing information and provide an indication of the cost as a function of time for both the historical matters and the new matter.

19. A management tool for a professional services firm that is operable to use historical billing information for a plurality of like, but completed matters to determine estimates for a new matter; calculate the number of professional hours and grade of fee earner needed for that new matter in order to adhere to a specified profit margin and provide an indication of the cost as a function of time for both the historical matters and the new matter.

20. A method for providing management information for a professional services firm involving using historical billing information for a plurality of like, but completed matters to determine estimates for a new matter; calculating the number of professional hours and grade of fee earner needed for that new matter in order to meet an estimated cost and providing an indication of the cost as a function of time for both the historical matters and the new matter.

21. A method for providing management information for a professional services firm involving using historical billing information for a plurality of like, but completed matters to determine estimates for a new matter; calculating the number of professional hours and grade of fee earner needed for that new matter in order to adhere to a specified profit margin and providing an indication of the cost as a function of time for both the historical matters and the new matter.
